(19) United States
(12) Patent Application Publication
(10) Pub. No.: US 2025/0340046 A1
(43) Pub. Date: Nov. 6, 2025

(54) DEVICE, IN PARTICULAR COMPOSITE BEAM, AND METHOD FOR PRODUCING AND FOR DISMANTLING THE DEVICE

(71) Applicant: HYCOBILITY Engineering & Technologies GmbH, Vienna (AT)

(72) Inventor: Erich WLASAK, Vienna (AT)

(73) Assignee: HYCOBILITY Engineering & Technologies GmbH, Vienna (AT)

(21) Appl. No.: 18/857,474

(22) PCT Filed: Apr. 19, 2022
(86) PCT No.: PCT/AT2022/060122

§ 371 Date: Oct. 17, 2024

(51) Int. Cl. B32B 15/10; B32B 1/00; B32B 43/00

(52) U.S. Cl. CPC B32B 15/10; B32B 1/00; B32B 43/006

(57) ABSTRACT

The invention relates to a device (1), in particular a composite beam, comprising: an outer body (2) having an interior (4); and a core (3) arranged in the interior (4), wherein: the core (3) comprises or is formed of a fibre composite material, in particular wood, that is swellable upon contact with a fluid; and the core (3) in the interior (4) is swollen by a fluid in an operating state and exerts, on the outer body (2), a pressure generated by the swelling.

The invention relates to a device, in particular a composite beam and a method for producing and for dismantling the device.

Beam-like devices or load-bearing elements are designed to accommodate loads and are known in the prior art in different material variations. On the one hand, in particular steel beams are used in the construction industry due to their high load-bearing capacity. On the other hand, wooden beams are also used for construction purposes and are a particularly ecological material for building projects.

For the above-mentioned reasons, the use of wood as a material would often be desirable, but the durability of wood in outdoor areas has been a major challenge for wood technology and the use of wood in technical elements for decades. This requirement very quickly becomes a limiting factor, in particular when supporting components or beams are subjected to static and dynamic loads, as wood loses strength and rigidity, sometimes dramatically, over long periods of time due to abiotic and biotic degradation.

The use of wood in technical applications poses technological and procedural challenges. The highly anisotropic material and raw material requires precise material expertise in its application, on the one hand, homogeneous and isotropic materials such as steel and plastic can be used to realise innovative, efficient and cost-effective solutions that would have been technically feasible in many cases with wood, but were not competitive from an economic point of view due to the more complex and elaborate shaping.

Further, calculations relative to homogeneous materials such as plastics and metals are easier to perform and these materials are also easier to control. This predictability has only been available for wood for a relatively short time.

In the past, wood was also widely used in a wide variety of technical products and apparatuses. An additional disadvantage of wood is its relatively low energy absorption in the event of breakage due to its brittle failure under tension. In the event of tensile failure, it is primarily sharp-edged fracture surfaces that are observed, which may lead to an increased risk of injury to persons involved in accidents, for example.

To overcome these disadvantages, chemical and/or physical wood modification is known in the prior art. Various methods are used to modify or impregnate wood cross-sections in whole or in part, which improves the properties of the material. In addition to increased durability and swelling minimisation, thermal modification initially results in a slight improvement in mechanical properties (rigidity and strength), a reduction in density and moisture absorption. However, wood modification leads to mechanical changes, for example embrittlement, as well as additional costs.

Another way to improve the durability of wood is to coating it. However, coating cannot fully guarantee protection. Impregnation with protective agents entails additional costs and involves the release of environmentally harmful substances. Plastic casings, on the other hand, have disadvantages when it comes to disposal and recycling after the component has been used.

Although wood-metal composites are known to overcome the disadvantages of wood, they represent a group of materials that has hardly been used and scientifically investigated to date.

Steel is known to have a high elastic limit and, in contrast to wood, has significantly better strength properties, in particular isotropic ones. However, the thermal conductivity of steel is also increased compared to wood, such that steel beams are naturally designed to conduct more heat in buildings than wood or similar fibrous materials. There may be restrictions on the use of wood compared to other building materials, in particular due to weather conditions.

Previous considerations currently include bonding and screwing wood and metal components together. In some cases, the two materials are joined by a plastic casing. These technical solutions also almost always involve major problems with disassembly and recycling.

The use of additional connecting means, wherein, for example, bores are provided in the beams and the individual components of the composite beam are finally screwed together, has considerable disadvantages. This may require notched cross-sections, which can represent a weak point in a structure in terms of strength, as the necessary bores for the screw connections can lead to notch cracking. Further, a composite beam created using connecting means also results in increased fabrication costs.

The problem of providing a device that overcomes the disadvantages of the prior art and combines certain advantageous properties of fibre composite materials, in particular wood, and metal may therefore be regarded as a conflict of objectives. Optionally, one object of the present invention is to overcome this conflict of objectives. Optionally, a further object of the invention is to provide a durable beam with improved thermal and strength properties for ecological building and construction projects without forming load-critical notch points that impair the fatigue strength of the beam. Optionally, a further object of the invention is to create a device, in particular a composite beam, which is particularly easy to produce but can also be disassembled or recycled.

These and further objects are optionally solved by a device and the methods having the features of the independent claims.

The present invention is in particular based on the observation that in particular hygroscopic fibre composites, such as wood, have the property of undergoing a strong dimensional change when absorbing polar fluids, i.e. liquids or gases, in particular when absorbing water, such as through contact with water or a change in humidity and/or a change in temperature.

The incorporation of polar fluids in the fibre composite structure leads to an increase in the volume of the material. This increase in volume is optionally also referred to as swelling in the context of the present invention. In addition to water, these swelling phenomena may also be caused by various polar liquids and substances, such as saline solutions, alcohols, ammonia, etc. The removal of fluids from the fibre composite material in turn causes a reduction in volume, also known as shrinkage.

The change in volume only occurs very little in the longitudinal direction, i.e. in the fibre direction of the fibre composite material, but mainly transverse to the fibre direction. In particular, a swellable fibre composite material, for example wood, in the context of the present invention has a main extension direction of the fibres. The swelling occurs in particular in the transverse direction to the main extension direction of the fibres.

Swelling and shrinkage is usually regarded as a major technical disadvantage in wood technology. In the prior art, attempts are often made to counteract the volume changes in wood. In the context of the present invention, however, it has surprisingly been achieved to exploit the swelling properties of fibre composite materials in an advantageous manner in order to solve at least one of the objects mentioned.

A device according to the invention optionally comprises a hollow profile-shaped outer body with an interior space and a core arranged in the interior space, wherein the core comprises or is formed from a fibre composite material, in particular wood, which is swellable on contact with a fluid. Optionally, it is provided that the core in the interior space is swollen by a fluid, in particular in an operating state, and exerts a pressure generated by the swelling on the outer body. In a preferred embodiment, the core is formed from wood or comprises wood. Alternatively or additionally, other materials, in particular bio-based or technical materials, which have a corresponding increase in volume due to water or other liquid or gas absorption or chemical reactions, may also be used.

The swelling properties, and in particular the hygroscopic properties, of the core may enable the core to be permanently bonded to the outer body. In particular, this may achieve at least one frictional connection, in particular a positive and frictional connection, between the core and the outer body, in particular the inner surface of the outer body.

The change in volume of the core due to its swelling optionally leads to plastic deformation of the core in a range of the contact surfaces of the outer body and core. This pressing area adjacent to the contact surfaces may also be referred to as the compaction area. In particular, the resulting compaction of the core, in particular of wood, transverse to the fibre leads to a significant increase in strength and rigidity along the fibre.

In addition to wood, a nanocellulose material, for example, may also be used as a fibre composite material. Optionally, the core comprises a compressed veneer material.

Depending on the curvature of the contact surfaces, the maximum equivalent stress acts in the core close to the outer surface of the core, such that optionally pressing deformations occur in the compaction area, resulting in an outward force against the outer body. This force leads to a normal force at the contact surfaces, in particular, to form a frictional connection in the transverse direction of the beam.

In the context of the present invention, a beam may be understood to be any elongated element or component which, in particular, has a larger dimension in the longitudinal extension direction than the largest dimension transverse to the longitudinal extension direction. A composite beam in the context of the present invention may, for example, be a load-bearing composite element. Such a beam may be used, for example, as a beam for building structures, as a pillar of an automotive chassis or body, as a supporting element of a lightweight structure, as a beam of a mechanical engineering structure or the like.

Positive-locking elements may optionally be provided to achieve an additional positive connection between the outer body and the core. Such positive-locking elements may be designed in different ways. For example, at least one positive-locking extension, for example in the form of a rib, may be arranged on the inner surface of the outer body. The positive-locking extension may press into a section of the core when the device is in the operating state, whereby a positive connection may be obtained. Optionally, the core may also have a positive-locking recess in which the positive-locking extension engages. The positive-locking recess may be a groove, for example.

The core and the outer body optionally run along a common main extension direction and the hollow outer body preferably encloses the core at least laterally, such that there is optionally a lateral connection between the outer body and the core. The main extension direction is thus to be regarded in particular as the direction corresponding to the largest spatial extension of the device. In particular, a lateral direction is to be regarded as a direction pointing orthogonally away from the main extension direction. In particular, the swelling of the core may be in a radial as well as a tangential direction.

In particular, the cross-section of the beam is to be understood as the surface section that extends transversely to the longitudinal extension direction. For example, the outer body may be a pipe, wherein the cross-section of the outer body is then circular and, in particular, closed. The term closed cross-section therefore refers in particular to a continuous cross-section without interruption, as is the case, amongst others, with a pipe cross-section.

Optionally, it is provided that the core exerts an internal pressure acting on the outer body in the operating state. A pressure that is distributed as evenly as possible enables the compaction zone, in which the pressing deformations occur, to be formed over an extensive area.

It may also be provided that the outer body has a closed cross-section. This can ensure that deforming of the cross-section is avoided as far as possible when the composite beam bears load. In particular, the closed cross-section ensures an even distribution of pressure between the core and the inner surface of the outer body.

In particular, it is provided that the pressure exerted by the core on the outer body in the operating state is at least 3 N/mm², in particular at least 5 N/mm² or at least 10 N/mm². Thus, under usual friction conditions between wood and steel, a sufficiently large normal force can be generated such that the core is held in the outer body.

Optionally, it is provided that the core is braced in the interior space in the operating state. As a result, the core can still be held dimensionally stable and, in particular, stable in the outer body without relative movements occurring at the contact surfaces when the beam is deformed if the composite beam is subjected to particularly high loads.

It is preferably provided that the outer body is designed as a metal profile, in particular as a steel profile. This can provide an outer body that is particularly suitable for the construction industry or for other constructions, for example for automotive engineering, mechanical engineering or plant engineering. Optionally, the device may be used as an overlay, replacing brick or steel overlays, for example.

Optionally, it is provided that the core is insertable and/or removable into the interior space in a joined state, wherein due to fluid absorption the core is more swollen in the operating state than in the joined state and/or wherein the core has a higher fluid content in the operating state than in the joined state. In particular, the core is loosely included in the outer body in the joined state and, in particular, there is no frictional connection between the core and the inner surface of the outer body.

In particular, the dimensions of the core are selected such that they can be pushed or inserted into the interior space of the outer body, for example a moulded pipe, an extrusion, etc., in the joined state. Optionally, the shaping of the core is selected such that the desired cross-section is produced by the material shrinkage during the reduction of the fluid content.

Facultatively, it may be provided that the core and interior space have a clearance fit in the joined state, wherein optionally the core is undersized relative to the interior space. This may be used to determine the extent of the frictional engagement between the core and the outer body in the swollen state. In addition, the core can be easily removed from the interior space of the outer body in the joined state.

It may be provided that the core completely fills the interior space of the outer body in the operating state. In this way, the outer surface of the core can be completely enclosed by the outer body and a firm connection between the bodies is achieved.

Optionally, it is provided that the core is fluid-tightly enclosed in the operating state. Thus, the core can be protected from fluid loss and shrinkage of the swelling in the swollen state. In particular, permanent stability of the device can be achieved.

Preferably, it is provided that the core is fluid-tightly enclosed by the outer body and by at least one closure arranged on the outer body. This may be another measure to prevent fluid loss. Alternatively or additionally, the core may be enclosed in a fluid-tight manner by a coating. In the context of the present invention, fluid-tight refers in particular to the property of a material of being substantially impermeable to a fluid, in particular the fluid that causes the swelling of the core. For example, in the case where the fluid is water, fluid-tight means in particular that the material is substantially impermeable to water in liquid and gaseous form.

Optionally, it is provided that the fluid is selected from one or more of the following fluids: Water, saline solution, alcohols, ammonia. A preferred fluid is water. Thus, the hygroscopic effect of wood can be exploited.

In particular, it is provided that the core has a compaction area along its outer circumference. Thus, the normal force for the frictional connection can be generated as a result of the deformation of the core. In addition, the mechanical properties of the core material are further improved in the compaction area.

Optionally, it is provided that the stress along the circumference of the profile cross-section of the outer body is increased by the pressure generated by the swelling. Thus, a pretensioned device can be formed.

It may be provided that an outer surface of the core is at least partially in direct contact with the inner side of the outer body, and/or that a connecting layer, for example an adhesive layer, is arranged between the outer surface of the core and the inner side of the outer body. This may provide a further measure to prevent relative movement between the core and outer body at the contact surfaces. Optionally, it may also be provided that the surface of the core is treated to improve the frictional connection. For example, the surface of the core may be roughened.

A frictional connection between the outer body and the core may also be improved by coating the wood surface with substances that increase the coefficient of friction or the adhesion properties to the inner side of the outer body. Substances that increase the coefficient of friction may, for example, be corundum-containing coating agents. Substances that increase the adhesive properties may be contact glues, for example.

In particular, it may be preferred to apply corresponding coatings to the inner side of the outer body to increase the adhesive properties. The interaction of the two coatings may lead to chemical reactions and thus to higher coefficients of friction or adhesion of both materials.

Optionally, the connection between the core and the outer body may be improved by oxidising the outer surface of the core and/or the inner surface of the outer body.

Optionally, the connection between the core and the outer body may be improved by chemically treating the surface of the core. Optionally, the treated core then reacts with the inner surface of the outer body.

Optionally, the connection between the core and the outer body may be improved by mechanical treatment of the outer body, for example by embossing and/or rolling.

Additional flat or point sensors, in particular pressure sensors, may be attached to the contact surface between the core and the outer body, for example to check the swollen condition of the core.

The outer surface of the core may also be a carrier of conductive tracks for current and signal routing.

Optionally, it is provided that the core is designed as a hollow body which optionally has a cavity running substantially in its longitudinal extension direction, in particular open on at least one side. This may make it easier to introduce the fluid to swell the core and remove it again if necessary. Optionally, it may be provided that the core is designed as a hollow profile.

The cavity may optionally also be used to insert pipes for transporting gas or liquids or conductive tracks into the device after the swelling process.

An inner profile body may optionally be arranged in the cavity, for example a pipe. Optionally, the core exerts a pressure on the inner profile body generated by its swelling.

Optionally, it is provided that the fluid is water, and/or that the fluid content of the core in the operating state is at least 1 wt. %, in particular 5 wt. %, preferably 10 wt. %, higher than in the joined state. Thus, sufficient swelling may optionally be achieved.

In particular, it is provided that the outer body and the core are frictionally engaged with each other.

Optionally, it is provided that the outer body has at least one positive-locking element on its inner side, in particular a positive-locking extension, for positive connection between the outer body and the core.

Optionally, it is provided that the core has at least one positive-locking recess for the engagement of a positive-locking extension.

Optionally, it is provided that the core is thermally modified, in particular by temperature treatment at at least 120° C., preferably at about 200° C. In particular, the core is thermally modified by temperature treatment between 120° C. and 250° C. Optionally, the core is thermally modified by temperature treatment for at least 5 minutes, preferably for at least 10 minutes. Optionally, the core is thermally modified by temperature treatment for a maximum of 30 minutes. Thus, the mechanical properties of the core can be improved.

Further, the invention optionally comprises a method of producing a device, in particular a composite beam. In particular, the device comprises a hollow profile-shaped outer body with an interior space and a core arranged in the interior space, wherein the core comprises or is formed from a fibre composite material, in particular wood, which is swellable on contact with a fluid. Optionally, the method comprises the following steps:
(a) providing the core, wherein the core has a first fluid content,
(b) inserting the core into the interior space of the outer body,
(c) increasing the fluid content of the core such that the core is swollen by the fluid and exerts a compressive force on the outer body generated by the swelling, wherein the core has a second fluid content.

Thus, a device according to the invention may be formed in an advantageous manner, wherein in particular a frictional connection exists between the outer body and the core.

Optionally, it is provided that the fluid is water, and/or that the second fluid content is at least 1 wt. %, in particular at least 5 wt.-%, preferably at least 10 wt. %, above the first fluid content. In particular, this may achieve sufficient swelling for the connection between the outer body and the core.

Optionally, it is provided that the core and interior space in step (b) have a clearance fit. In particular, this can be used to determine the normal force acting on the connection in the operating state.

Optionally, it is provided that the fluid is water, and that the first fluid content is at most 10 wt. %, in particular at most 5 wt. %, and/or that the first fluid content is below the equilibrium moisture content of the fibre composite material of the core at a temperature of 20° C. and a relative humidity of 50%. In particular, the first fluid content may be below the equilibrium moisture content of the fibre composite material of the core by at least 5 wt. %, optionally by at least 10 wt. %, at a temperature of 20° C. and at a relative humidity of 50%.

Optionally, the moisture is largely or completely removed from the core by drying or by other methods. The wood loses volume due to the dehydration. Thus, the core can be inserted into the interior space of the outer body in the joined state.

Optionally, it is provided that the method additionally comprises the following step: (d) forming positive-locking elements by deforming the outer body. Thus, additional constraining forces can be achieved between the outer body and the core, securing the bodies to each other.

Optionally, it is provided that the method additionally comprises the following step: (d) rolling of the device. Thus, the core can be compacted, which further improves the mechanical properties.

Optionally, the core is covered with liquid and/or gaseous water between step (a) and step (b).

Optionally, the core is chemically treated before step (b), for example with ammonia, to enable better swelling.

The present invention optionally further relates to a method of dismantling a device, in particular a composite beam. In particular, the device optionally comprises a hollow profile-shaped outer body with an interior space and a core arranged in the interior space, wherein the core comprises or is formed from a fibre composite material, in particular wood, which is swellable on contact with a fluid. Optionally, the method comprises the following steps:
(a) providing the device, the core in the interior space is swollen by a fluid and exerts, on the outer body, a compressive force generated by the swelling, wherein the core has a second fluid content,
(b) reducing the fluid content of the core such that the core has a first fluid content,
(c) removing the core from the outer body.

Thus, a device may optionally be separated and its individual parts may be recycled separately.

Optionally, it is provided that reducing the fluid content of the core in step (b) is achieved by heating the core. Thus, the pressure acting between the outer body and the core may be reduced, such that, in particular, there is no longer a frictionally engaged and/or positive connection between the outer body and the core.

Optionally, it is provided that the fluid is water, and/or that the second fluid content is at least 1 wt. %, in particular at least 5 wt.-%, preferably at least 10 wt. %, above the first fluid content. In particular, this may result in the shrinkage required to release the connection.

Optionally, it is provided that the core and interior space in step (c) have a clearance fit.

In a device, it may also be provided that the fibres of the core extend substantially in the main extension direction of the core.

The cross-section of the core and/or the outer body may be quadrangular, in particular rectangular or square, round, polygonal, hyperbolic, convex, concave, trapezoidal, elliptical, hexagonal, manifold, rhomboid, deltoid, T-shaped, U-shaped or even polygonal. Thus, a suitable cross-section can be provided for different applications.

Optionally, it is provided that in the operating state, the structural mechanical compression energy of the core corresponds to the structural mechanical expansion energy of the outer body.

Optionally, it is provided that the radial cross-section of the device has the same area moment of inertia around both main stress axes.

It may be provided that the core is formed in an integral or multi-piece design. For example, it may be provided that the core has several separate sections.

Optionally, it is provided that the cross-section of the device has different area moments of inertia around both main stress axes and/or that the shape of the core is adapted to the shape of the interior space.

Optionally, it is provided that the device has a dimension in the joined state that allows the core to be inserted into and removed from the interior space of the outer body, and that the device has a swollen size in the operating state such that there is a firm connection between the core and outer body. Optionally, this dimension is an oversize or undersize of a clearance fit.

Optionally, it is provided that the addition of a fluid to the core is reversible, wherein after a reduction of the fluid content, in particular the wood moisture, in the core, the core is removed from the outer body.

In additional embodiments, the following features may additionally or alternatively be provided in a device and/or method of the invention:

Optionally, a recyclable joining technology for wood-metal composites is provided. In particular, the core and outer body are joined by a hydro-thermal method and optionally separated again. The material wood, which in particular is hygroscopic, optionally has the property of changing volume when it absorbs moisture through contact with water or changes in humidity and/or temperature.

The incorporation of water in the wood structure of a core may lead to an increase in volume. This property may be referred to as swelling.

In the case of water, the increase in volume optionally occurs in a wood moisture range of 0 to about 30 wt. %, the fibre saturation range. Above this value, usually no changes in volume are observed.

Optionally, the core is or will be pre-compacted to favour subsequent compaction during swelling. Due to the compression pressure that occurs when wood swells (theoretical compression pressure of a lignified cell wall ˜about 500 N/mm²) and the low transverse compressive strength of wood (in a range of about 1 to 15 N/mm², depending on the type of wood), the wood material of the core is optionally compressed by the outer body.

Plastic deformation of wood in a radial or tangential direction can be achieved more easily with increased moisture or temperature or after chemical pre-treatment.

Optionally, a multi-layer core may also be constructed from optionally pre-compressed layers of wood and other materials, for example as ceramic, plastic, metal, metal foams, etc.

It is also possible to deform the device by applying external compression pressure. This may optionally change the moment of inertia or selectively compact the core. The core may be joined to the outer body by the swelling process or the additional forming process by positive locking and friction engagement. This join connection may also be improved by a special surface design such as roughening or undercuts.

Furthermore, the device may also be plastically deformed by bending devices, for example a profile bending machine.

Pre-compaction of the core optionally increases rigidity and strength. In particular, the wooden body or core may be compacted in its peripheral areas by the joining process, which increases strength and rigidity and improves the overall mechanical properties of the device. A substantial advantage of the device is, in particular, that a ductile fracture with increased energy absorption occurs when the device is overstressed.

In particular, the absorbable fracture energy can be further increased by compacting the core. After the increase in volume, the device is sealed at the front on both sides, whereby the swollen state of the wood is permanently preserved by the diffusion tightness of the metal and the sealing material, for example PU rigid foam or other plastics.

The seal at the end face of the outer body may be achieved by caps of different shapes and materials. The caps may be connected to the outer body by a frictional, positive and/or material bond.

In the case of frictional and material bonding, the caps can simply be released again by screwing them down, pulling them off or heating them.

The device may also be disassembled or dismantled by removing the fluid-tight enclosure of the core and exposing the device to atmospheric or physical conditions in which the core again loses moisture or other fluids and shrinks. The shrinkage process optionally continues until the two joined parts can be separated again.

Optionally, a substantial advantage of the method is that the metal component or outer body and the wood component or core can be put to secondary use or recycled. In addition, by increasing the mechanical properties of the composite, the dimensions of the components are optionally reduced and material is saved.

If the outer body is steel, the recycling process in the blast furnace requires the addition of carbon dioxide and heat. The energy stored in the core and the chemical components can save energy and coal in the recycling process.

The outer body may also be formed from or comprise another non-swellable and diffusion-tight material such as ceramic, plastic or fibre-reinforced plastic.

The device of the present invention optionally allows one or more of the following advantages over conventional geometrically similar steel beams:
Improvement in deflection with approximately the same load and mass of at least 2%, optionally 8%.
Reduction of raw material costs by up to 40% while maintaining the same mass
Reduction of carbon dioxide emissions during production by up to 20% while maintaining the same mass

If high cores are used, raw material costs may optionally be reduced by up to 50% and carbon dioxide emissions by up to 40%.

Further features of the present invention are apparent from the description of the exemplary embodiments, the figures and the claims.

In the following, the invention is explained in detail by means of non-exclusive, merely exemplary embodiments.

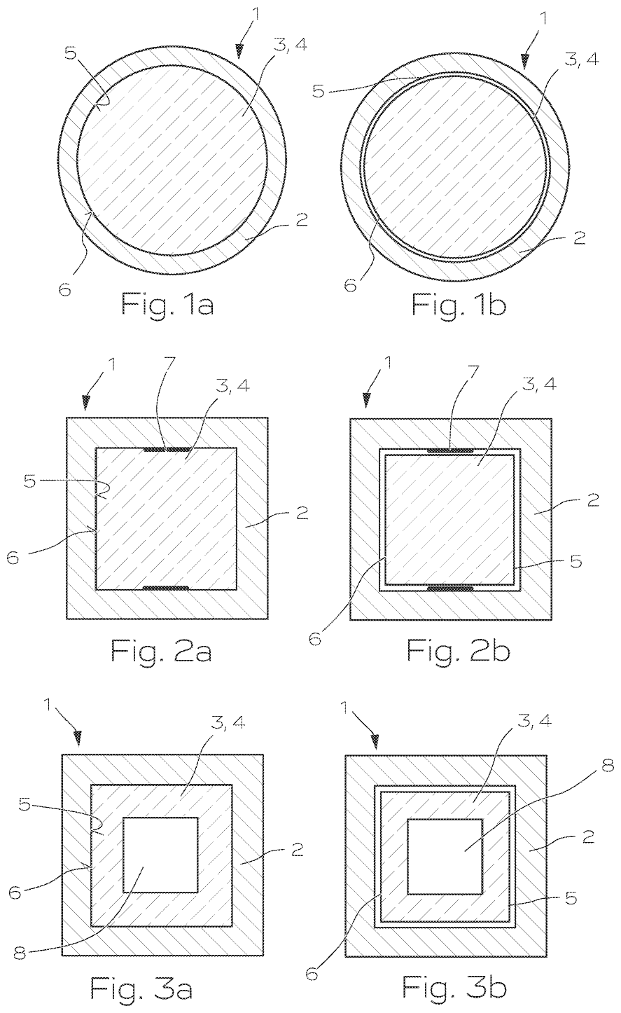

FIG. 1a shows an embodiment of a device according to the invention in a schematic representation in the operating state according to a first exemplary embodiment;

FIG. 1b shows the device according to the first exemplary embodiment in the joined state;

FIG. 2a shows an embodiment of a device according to the invention in a schematic representation in the operating state according to a second exemplary embodiment;

FIG. 2b shows the device according to the second exemplary embodiment in the joined state;

FIG. 3a shows an embodiment of a device according to the invention in a schematic representation in the operating state according to a third exemplary embodiment;

FIG. 3b shows the device according to the third exemplary embodiment in the joined state

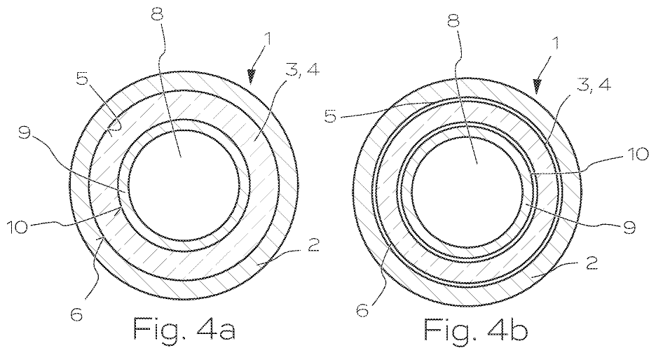

FIG. 4a shows an embodiment of a device according to the invention in a schematic representation in the operating state according to a fourth exemplary embodiment;

FIG. 3b shows the device according to the fourth exemplary embodiment in the joined state.

Unless otherwise indicated, the figures show the following features: Composite beam 1, outer body 2, core 3, interior space 4, interior surface 5, outer surface 6, positive-locking extension 7, cavity 8, inner profile body 9, outer surface 10.

FIG. 1a shows an embodiment of a device according to the invention in the operating state according to a first exemplary embodiment. FIG. 1a shows the device in a schematic sectional view, wherein the sectional plane is arranged substantially orthogonal to the longitudinal extension direction of the device.

The device is designed as a composite beam 1 with a circular cross-section and comprises a hollow-profile shaped outer body 2 with an interior space 4. A core 3 is arranged in the interior space 4. The core 3 is swellable on contact with a fluid and is made of wood in this embodiment. FIG. 1a shows the composite beam in its operating state, i.e. the core 3 is swollen. In this state, the core 3 in the interior space 4 is swollen by water and exerts pressure on the outer body 2 due to the swelling. The outer surface 6 of the core 3 is in direct contact with the inner surface 5 of the outer body 2.

In other embodiments not shown, a connecting layer, for example an adhesive layer, is arranged between the outer surface 6 of the core 3 and the inner side 5 of the outer body 2.

In this exemplary embodiment, the outer body 2 is designed as a tubular steel profile. The core 3 is an elongated, substantially cylindrical rod made of wood.

The core 3 is fluid-tightly enclosed in the interior space 4 of the outer body 2, with plastic closures being provided at the two open ends of the outer body 2 (not shown). Thus, the fluid content of the core 3 can be kept substantially constant even under changing external conditions.

FIG. 1b shows an embodiment of a device according to the invention in a joined state. In this state, the outer surface 6 of the core 3 is spaced apart from the inner side 5 of the outer body 2, so in particular there is a clearance fit between the core 3 and the inner surface 5 of the outer body 2. For further features, see the description of FIG. 1a.

In particular, the device may assume the joined state during production of the device or the composite beam 1. In the joined state, the core 3 may be inserted into the interior space 4 of the outer body 2. By increasing the water content, the composite beam 1 is brought into the operating state such that the core 3 presses with its outer surface 6 against the inner surface 5 of the outer body 2.

In this exemplary embodiment, the water content of the core 3 is about 25 wt. % in the operating state and about 10 wt. % in the joined state.

If the composite beam is to be disassembled, at least one closure is removed. Then, the excess moisture can escape and the core 3 shrinks, which in turn leads to a joined state in which the core 3 may be removed from the interior space 4 of the outer body 2. The escape of moisture may be enhanced by heating the device.

FIG. 2a shows an embodiment of a device according to the invention in a schematic representation in the operating state according to a second exemplary embodiment. FIG. 2b shows the device according to the second exemplary embodiment in the joined state. FIGS. 2a and 2b each show the device in a schematic sectional view, wherein the sectional plane is arranged substantially orthogonal to the longitudinal extension direction of the device.

The composite beam 1 according to the second exemplary embodiment largely corresponds to the beam according to the first exemplary embodiment described in detail.

In contrast to the first exemplary embodiment, the core 3 and the outer body 2 in the second exemplary embodiment have a square cross-section.

Further, positive-locking extensions 7 in the form of ribs are arranged on the inner surface 5 of the outer body 2. In the operating state, the positive-locking extensions 7 press into the surface of the core 3, which also creates a positive connection between the core and the outer body. The ribs are arranged at regular intervals along the longitudinal extension direction of the composite beam 1.

In addition, in contrast to the first exemplary embodiment, there is no fluid-tight enclosure of the core 3 in the interior space 4 of the outer body 2. In this exemplary embodiment, the outer body 2 is open on both sides. In this exemplary embodiment, the frictional connection between core 3 and outer body 2 is achieved by bringing the water content of the core 3 in the joined state below the water content that corresponds to the moisture content equilibrium of the core material at a temperature of 20° C. and a relative humidity of 50%. The core is therefore dried, such that its water content is in particular less than 5 wt. %.

In the joined state, there is also no longer a positive connection between the positive-locking elements 7 and the core 3.

In the joined state, the core 3 can be inserted into the interior space 4 of the outer body. The composite beam 1 then remains at ambient conditions and the water content of the core 3 will gradually increase until the water content corresponds to the moisture content equilibrium. The device is then in the operating state, achieving a similar effect to the first exemplary embodiment. However, a fluid-tight closure is not required, which further simplifies the design.

To disassemble the device, the composite beam 1 can be heated such that the fluid content of the core 3 is reduced.

FIG. 3a shows an embodiment of a device according to the invention in a schematic representation in the operating state according to a third exemplary embodiment. FIG. 3b shows the device according to the third exemplary embodiment in the joined state. FIGS. 3a and 3b each show the device in a schematic sectional view, wherein the sectional plane is arranged substantially orthogonal to the longitudinal extension direction of the device.

The third exemplary embodiment corresponds substantially to the second exemplary embodiment, with the exception that the core 3 is designed as a hollow body which has a cavity 8. This favours the change in water content, wherein the larger free surface area enables a faster change in water content in particular. In this exemplary embodiment, the core 3 is configured as a box profile. The cavity 8 may be used for pipes, lines, cabling and the like.

In an exemplary embodiment not shown, positive-locking extensions may also be provided in this embodiment.

Additionally, in contrast to the second exemplary embodiment, no positive-locking extensions 7 are provided.

FIG. 4a shows an embodiment of a device according to the invention in a schematic representation in the operating state according to a fourth exemplary embodiment. FIG. 4b shows the device according to the fourth exemplary embodiment in the joined state. FIGS. 4a and 4b each show the device in a schematic sectional view, wherein the sectional plane is arranged substantially orthogonal to the longitudinal extension direction of the device.

The fourth exemplary embodiment corresponds substantially to the third exemplary embodiment, with the difference that the outer body 2 and the core 3 are designed to be in the shape of a hollow cylinder. An inner profile body 9, which in this exemplary embodiment is a steel pipe, is arranged in the cavity 8 of the core 3.

In the operating state, as shown in FIG. 4a, the core 3 presses on the inner surface 5 of the outer body 2 and on the outer surface 10 of the inner profile body 9 due to the swelling.

In this exemplary embodiment, the device can be used as a load-bearing component and at the same time as a pipe for transporting liquids or gases, for example as a water pipe.

1. A device, in particular a composite beam, comprising a hollow profile-shaped outer body having an interior space and a core arranged in the interior space, wherein the core comprises or is formed from a fibre composite material, in particular wood, that is swellable upon contact with a fluid, wherein the core in the interior space is swollen by a fluid in an operating state and exerts, on the outer body, a pressure generated by the swelling.

2. The device according to claim 1, wherein the core exerts an internal pressure acting on the outer body in the operating state.

3. The device according to claim 1, wherein the outer body has a closed cross-section.

4. The device according to claim 1, wherein the pressure exerted by the core on the outer body in the operating state is at least 3 N/mm², in particular at least 5 N/mm² or in particular at least 10 N/mm².

5. The device according to claim 1, wherein the core is braced in the interior space in the operating state.

6. The device according to claim 1, wherein the outer body is designed as a metal profile, in particular as a steel profile.

7. The device according to claim 1, wherein the core is insertable and/or removable into the interior space in a joined state, wherein due to fluid absorption the core is more swollen in the operating state than in the joined state and/or wherein the core has a higher fluid content in the operating state than in the joined state.

8. The device according to claim 1, wherein the core and interior space have a clearance fit in the joined state, wherein optionally there is an undersize of the core relative to the interior space.

9. The device according to claim 1, wherein the core completely fills out the interior space of the outer body in the operating state.

10. The device according to claim 1, wherein the core is fluid-tightly enclosed in the operating state.

11. The device according to claim 1, wherein the core is fluid-tightly enclosed by the outer body and by at least one closure arranged on the outer body.

12. The device according to claim 1, wherein the fluid is selected from one or more of the following fluids: Water, saline solution, alcohol, ammonia.

13. The device according to claim 1, wherein the core has a compaction area along its outer circumference.

14. The device according to claim 1, wherein the stress along the circumference of the profile cross-section of the outer body is increased by the pressure generated by the swelling.

15. The device according to claim 1, wherein an outer surface of the core is at least partially in direct contact with the inner side of the outer body, and/or in that a connecting layer, for example an adhesive layer, is arranged between the outer surface of the core and the inner side of the outer body.

16. The device according to claim 1, wherein the core is designed as a hollow body which optionally has a cavity running substantially in its longitudinal extension direction, in particular open on at least one side.

17. The device according to claim 1, wherein an inner profile body is arranged in the cavity, wherein the core exerts a pressure on the inner profile body generated by its swelling.

18. The device according to claim 1, wherein the fluid is water, and/or in that the fluid content of the core in the operating state is at least 1 wt. % higher than in the joined state.

19. The device according to claim 1, wherein the outer body and the core are frictionally engaged with each other.

20. The device according to claim 1, wherein the outer body has at least one positive-locking element on its inner side, in particular a positive-locking extension, for the positive connection between the outer body and the core.

21. The device according to claim 20, wherein the core has at least one positive-locking recess for engagement of the positive-locking extension.

22. A method of manufacturing a device, in particular a composite beam, comprising a hollow profile-shaped outer body having an interior space and a core arranged in the interior space, wherein the core comprises or is formed from a fibre composite material, in particular wood, that is swellable upon contact with a fluid, wherein the method comprises the following steps:
(a) providing the core, wherein the core has a first fluid content,
(b) inserting the core into the interior space of the outer body,
(c) increasing the fluid content of the core such that the core is swollen by the fluid and exerts a compressive force on the outer body generated by the swelling, wherein the core has a second fluid content.

23. The method according to claim 22, wherein the fluid is water, and/or that the second fluid content is at least 1 wt. %, in particular at least 2 wt. %, above the first fluid content.

24. The method according to claim 22, wherein the core and interior space in step (b) have a clearance fit.

25. The method according to claim 22, wherein the fluid is water, and in that the first fluid content is at most 10 wt. %, in particular at most 5 wt. %, and/or in that the first fluid content is below the equilibrium moisture content of the fibre composite material of the core at a temperature of 20° C. and a relative humidity of 50%.

26. The method according to claim 22, wherein the method further comprises the following step:
(d) forming positive-locking elements by deforming the outer body.

27. A method for dismantling a device, in particular a composite beam, comprising a hollow profile-shaped outer body having an interior space and a core arranged in the interior space, wherein the core comprises or is formed from a fibre composite material, in particular wood, that is swellable upon contact with a fluid, wherein the method comprises the following steps:
(a) providing the device, wherein the core in the interior space is swollen by a fluid and exerts, on the outer body, a compressive force generated by the swelling, wherein the core has a second fluid content,
(b) reducing the fluid content of the core such that the core has a first fluid content,
(c) removing the core from the outer body.

28. The method according to claim 27, wherein reducing the fluid content of the core in step (b) involves heating the core, in particular to a temperature of above 50° C., preferably above 100° C.

29. The method according to claim 27, wherein the fluid is water, and/or that the second fluid content is at least 1 wt. %, in particular at least 2 wt. %, above the first fluid content.

30. The method according to claim 27, wherein the core and interior space in step (c) have a clearance fit.
